(19) United States
(12) Patent Application Publication
(10) Pub. No.: US 2026/0029373 A1
(43) Pub. Date: Jan. 29, 2026

(54) DIFFERENTIAL ION MOBILITY ANALYSIS

(71) Applicant: SHIMADZU CORPORATION, Kyoto-shi (JP)

(72) Inventors: Roch ANDRZEJEWSKI, Manchester (GB); Roger GILES, Manchester (GB); Andrew ENTWISTLE, Manchester (GB)

(21) Appl. No.: 19/114,703

(22) PCT Filed: Sep. 23, 2022
(86) PCT No.: PCT/EP2022/076480

§ 371 Date: Mar. 24, 2025

(51) Int. Cl. G01N 27/623; H01J 49/00; H01J 49/24

(52) U.S. Cl. CPC G01N 27/623; H01J 49/0031; H01J 49/24

(57) ABSTRACT

A method of analyzing ions comprising generating ions from a sample in an ion source, delivering them into a vacuum region of a vacuum enclosure comprising an ion mobility analyser having an ion drift region formed between opposing electrodes defining an analytical gap. The ions emerge from the ion inlet as a supersonic jet of a buffer gas within which the ions are entrained to enter the drift region and, e.g., prior to mass spectral analysis of the ions in a downstream vacuum region, conducting differential ion mobility analysis of the ions in the first vacuum region. Prior to conducting differential ion mobility analysis (e.g., and mass spectral analysis) according of the ion, the method comprises
a) changing a rate of flow of gas into or out of the vacuum region;
b) measuring a gas pressure in the vacuum region and repeating steps a) and b) until a target gas pressure value is achieved;
c) measuring a velocity of gas flow along the drift region and repeating steps a) to c) until the measured gas velocity value has achieved a pre-set target gas velocity value and subsequently conducting said differential ion mobility analysis and said mass spectral analysis according to said target gas pressure value and said target gas velocity value.

### FIELD OF THE INVENTION

The present invention relates to ion mobility spectrometry (IMS) and particularly, although not exclusively, to Field asymmetric IMS (FAIMS), differential mobility spectrometry (DMS).

### BACKGROUND

The term ion mobility spectrometry (IMS) refers to the methods and apparatus used to characterise ions from sample substances in terms of the speed at which ensembles of those ions progress through a supporting gas atmosphere when urged through it by an applied electric field. Ion mobility measurements involve injecting an ion ensemble into a “drift region”, often using an ion shutter at the entrance of the drift region to control the timing of the injection process. An ion detector, or simply an ion outlet, may be provided at the output end of the drift region. While within the drift region, the ion ensemble moves longitudinally towards an output end of the drift region within a flow of purified neutral support gas (e.g., molecular Nitrogen), also known as a “buffer gas”, in which it is entrained. Simultaneously, the ion ensemble moves transversely to the buffer gas flow direction under the urging force of an applied electric field, E, generated by an appropriate voltage gradient applied transversely to the buffer gas flow direction. Notably, ion mobility measurements pertain only to ion ensembles and not to individual ions for which the speeds can be comparatively large. For example, the median speed between collisions for molecular Nitrogen ions at ambient pressure and at a temperature of 25 degrees Celsius is about 450 metres per second. By comparison, as an example, an ion ensemble may typically be urged by the applied electric field, E, to move transversely to the buffer gas flow direction with a velocity of, say, v=4 m/s.

It is established practice to normalise such an ion ensemble velocity value, v, by dividing it with the value of the electric field strength, E, applied transversely to the buffer gas flow direction. This normalisation produces an ion mobility coefficient, K=v/E, which is the measure of the ion ensemble velocity per unit field strength. The relationship between ion ensemble velocity, v, and electric field strength, E, is valid for an ion ensemble at thermal energies measured in a buffer gas atmosphere of constant composition, pressure, and temperature. Importantly, the value of an ion mobility coefficient is dependent upon buffer gas temperature, T, and pressure, P, inside the drift region. As a result, an ion mobility coefficient, K, is sensitive to fluctuations in both of these quantities.

A distinction of IMS in contrast to mass spectrometry, MS, is that ions are characterised in a supporting buffer gas atmosphere, also called a drift gas, that is refreshed continuously. A main practical purpose of this gas is to maintain a purified and constant atmosphere for collision-based movement of the ion ensemble.

Field asymmetric IMS, differential mobility spectrometry, or ion drift spectrometry are different names given to the same process, which is a type of IMS. An ion mobility measurement begins when ions formed from components in a sample, called product ions, are injected into the drift region. These methods are based on ions undergoing changes in ion mobility coefficients, K, as a result of changes in the applied transverse field, E, at constant buffer gas particle number density, N, i.e., the number of buffer gas particles per unit volume. In particular:

$$K ( E / N ) = {K}_{0} ( 1 + α ( E / N ) )$$

$$Here ,$$

$$α ( E / N ) = {α}_{2} \times {( E / N )}^{2} + {α}_{4} \times {( E / N )}^{4} + … + {α}_{2 n} \times {( E / N )}^{2 n}$$

The terms α₂ₙ (n=1, 2, . . . ) are constant coefficients the values of which are particular to a given combination of ion and buffer gas set-up. The function α(E/N) is a function describing the dependence of ion mobility on the ratio, E/N, of the electric field strength to neutral gas density. The units of E/N are Townsends (Td) where 1 Td=10⁻¹⁷ Vcm². This function describes the non-linear electric field dependence of ion mobility of an ion. An approach in IMS technology has enabled studies of field dependence using a Field Asymmetric Ion Mobility Spectrometer (FAIMS) or DMS. The method of high field asymmetric IMS for ion separations is based on a non-linear, high field dependence of ion mobility coefficients.

In this method, termed variously Field Asymmetric IMS (FAIMS), or Differential Mobility Spectrometry (DMS), ions are entrained by a gas flow through a drift space between conducting surfaces (e.g., electrodes). The space between the electrodes defines an “analytical gap”. The drift space can be defined between parallel curved or flat electrodes (e.g., plates). A transverse electric field, E, is applied across this analytical gap using an asymmetric voltage waveform known as a “dispersion voltage” (V_{D}), which generates a corresponding dispersion electric field, E_{D}: e.g., of E_{D}=+20,000 V/cm or greater in positive amplitude part of the asymmetric wave cycle and E_{D}=−1,000 V/cm in the negative amplitude part of the asymmetric wave cycle. lon ensembles move with a speed v within the electric field E according to equations:

$$\begin{matrix}K = v / {E}_{D} \\ K ( {E}_{D} / N ) = {K}_{0} ( 1 + α ( {E}_{D} / N ) )\end{matrix}$$

Of course, the value of E_{D} changes in magnitude and polarity as the wave cycle switches between its positive and negative amplitude parts. As a result, the value of K(E_{D}/N) is different during these two different parts of a wave cycle for ions for which α(E_{D}/N)≠0. The asymmetric voltage waveform of the dispersion voltage (V_{D}) is designed so that the integrals of these two parts of the wave cycle are equal. Notably, ions with mobility coefficients, K(E_{D}/N), that are independent of E_{D}, (i.e., such that α(E_{D}/N)=0 even at high field values) are able to pass through the drift region and emerge from it to be detected. In contrast, ions with a dependence of K on E_{D} (i.e., α(E_{D}/N)≠0) undergo a net displacement towards a surface of an electrode with repeated exposure of the ion ensemble to the periodic changes in direction and strength of the electric field, E_{D}. The magnitude of displacement depends on the differences in mobility, K(E_{D}/N), at electric field extremes (i.e., the positive and negative amplitude parts of the asymmetric wave cycle).

The immediate effects of dispersion electric field, E_{D}, in DMS or FAIMS are revealed in the dependence of the mobilities, K(E_{D}/N), of ions on dispersion electric field strength, E_{D}, at the two extremes of the asymmetric waveform. The waveform is designed in field strength, E_{D}, and duty cycle (as between durations of positive polarity and negative polarity parts) so that an ion with little or no dependence of mobility on dispersion electric field strength, E_{D}, will pass through the centre of the analyser carried by a flow of buffer gas. Ions that do have a dependence of mobility on dispersion electric field strength, E_{D}, will undergo with each complete cycle of the dispersion voltage waveform, successive net displacements from the central ion axis of ion flow. Eventually, the ion ensemble will collide with an electrode defining the analytical gap and will be discharged and removed from the measurement process. When a direct current “compensation voltage” is applied to the electrodes of the analyser, the effects of the dispersion electric field may be compensated, and ion motion can be restored to the centre of the analyser.

A comparatively low direct current (DC) “compensation voltage” (V_{C}) may be added to the electrodes or plates defining the analytical gap so as to superimpose that DC electric field upon the dispersion electric field, E_{D}, to enable control or “compensation” of ion motion towards an electrode. Ions restored to the centre of the analytical gap will be made able to pass through the drift region. A sweep of this compensation voltage, often 10V to 40V in size (producing electric fields of typically 100V/cm to 500V/cm), provides a means to measure mobility of all ions in the analyser for a given dispersion voltage wave form. This method provides ion mobility filtering, and ion separations are based on differences in ion mobility, leading to the name “Differential Mobility Spectrometry”, also known as FAIMS.

Patent document U.S. Pat. No. 8,610,054 B2 discloses an ion analysis apparatus and method employing vacuum differential ion mobility spectrometry (DMS) combined with mass spectrometry. The disclosure teaches the use of operating pressures for buffer gasses within which ions are entrained for providing Field Asymmetric lon Mobility (FAIMS) analysis.

Patent document U.S. Pat. No. 8,084,736 B2 discloses a method and system for a vacuum-driven differential ion mobility spectrometry/mass spectrometry interface with adjustable resolution and selectivity.

To achieve high quality measurements, the appropriate control of the speed of gas flow in the analytical gap is necessary. The present invention has been devised in light of the above considerations.

### SUMMARY OF THE INVENTION

At its most general, the invention proposes a method for (and apparatus configured for) analyzing ions by lon Mobility Spectrometry (IMS) by generating ions from a sample in an ion source, delivering them entrained in a buffer gas (preferably the buffer gas is a supersonic jet) into an ion mobility analyser in a vacuum region containing an ion drift region formed between electrodes defining an analytical gap. Prior to conducting differential ion mobility analysis of the ions, one may implement a process of:
a) changing a rate of flow of gas into or out of the vacuum region;
b) measuring a gas pressure in the vacuum region; and, repeating steps a) and b) until the measured gas pressure value achieves a pre-set target gas pressure value;
c) measuring a velocity of gas flow along the drift region; and,
   repeating steps a) to c) until the measured gas velocity value achieves a pre-set target gas velocity value; and, subsequently conducting differential ion mobility analysis of the entrained ions according to the target gas pressure value and the target gas velocity value. In this way, the pre-set target gas velocity and pre-set target gas pressure may be achieved ready for use in subsequent differential ion mobility analysis (DMS or FAIMS) either as a stand-alone ion mobility spectral analysis or as an upstream part of a larger spectral analysis, such as for providing a downstream ion input to a mass spectrometer.

As a result, the velocity of buffer gas flow (and entrained ion flow) through the drift region may be controlled independently of the value of the gas pressure within the first vacuum region.

Preferably the buffer gas is a supersonic jet. Most desirably, the flow of gas (and entrained ions) through the drift region is driven by (e.g., the gas flow momentum being provided predominantly by, or substantially wholly by) the supersonic jet of buffer gas rather than by a pressure difference between the gas inlet and gas outlet ends of the drift region. For example, preferably, a pressure difference between the gas inlet and gas outlet ends of the drift region may be negligibly small.

### Choked flow

There is a limit to the maximum mass flow of a fluid through a supersonic jet of buffer gas. This phenomenon starts at the throat of the gas outlet at sonic conditions and continues along the jet when the fluid downstream can no longer communicate with the flow upstream. This is because the maximum speed at which the information of the fluid properties propagates through the flow is at the speed of sound. In the jet the flow is supersonic and the fluid moves faster than the speed of sound. This makes the fluid properties at the gas outlet independent of the fluid properties downstream. Any further expansion of the flow in the jet that increases velocity and reduces pressure will not increase the mass flow rate any further. When this happens, the flow is said to be “choked” and the mass flow rate is determined by the gas outlet aperture area independently of how low the exit pressure is. Choked flow is a limiting condition where the mass flow will not increase with a further decrease in the downstream pressure environment for a fixed upstream pressure and temperature. The choked flow of gases causes a condition in which the mass flow rate is independent of the downstream pressure.

According to the invention, a supersonic jet is created at the ion source outlet (e.g., a capillary) into the first vacuum region. This is formed due to a significantly high pressure difference maintained between the ion source (e.g., an atmospheric pressure ion source) and the first vacuum region (at significantly sub-ambient pressure) of an lon Mobility Spectrometry (IMS) apparatus (e.g., a low-pressure FAIMS apparatus (LP-FAIMS)). A Mach region is formed under these condition at the exit of the ion source (e.g., a capillary), and this forms a supersonic gas jet. The emergent gas jet is characterised by jet pressure ratio (JPR) which typically has a JPR value of JPR>1.5, and typically a JPR value of JPR>5, or more preferably of JPR>10, or yet more preferably of JPR>15, such as a JPR value of about twenty (JPR=20). A jet is supersonic if JPR≥1.5.

The emergent jet is most preferably under-expanded and supersonic, and the flow of gas in the jet is most preferably choked. This means that decreasing the down-stream pressure in the jet does not lead to an increase in the gas jet velocity or throughput. The invention provides a process and apparatus for controllably monitoring and adjusting the speed of drift of buffer gas, and entrained ions, through the drift region of an lon Mobility Spectrometry (IMS) apparatus under these circumstances.

Accordingly, in a first aspect, the invention may provide a method of analyzing ions, which method comprises:
generating ions from a sample in an ion source;
delivering the ions through an ion inlet into a vacuum region of a vacuum enclosure comprising a differential ion mobility analyser which comprises an ion drift region formed between opposing electrodes defining an analytical gap, wherein the ions emerge from the ion inlet as a supersonic jet of a buffer gas within which the ions are entrained to enter the drift region;
delivering the ions from the differential ion mobility analyser to an ion detector to generate one or more ion mobility spectral peaks;
wherein the method comprises:
   a) changing a rate of flow of gas into or out of the vacuum region;
   b) measuring a gas pressure in the vacuum region and comparing the measured gas pressure value to a target gas pressure value;
repeating steps a) and b) until a said gas pressure comparison indicates that the measured gas pressure value has achieved said target gas pressure value;
   c) measuring a velocity of gas flow along the drift region by applying a gate voltage pulse across the analytical gap so as to act as an ion shutter, detecting an ion mobility spectral peak generated by the ion detector and adjusting a pulse width of the gate voltage pulse such that the detected ion mobility spectral peak achieves a reduced height (H2) which is less than a detected maximum height (H1) for that ion mobility spectral peak according to a pre-set relative proportion, R, where R=H2/H1, and determining the gas flow velocity according to the ratio, v, of the pulse width, T, and the axial length, L, of the drift region such that v=L/T;
repeating steps a) to c) until a said measured gas velocity value has achieved a pre-set target gas velocity value and subsequently conducting differential ion mobility analysis by the differential ion mobility analyser according to said target gas pressure value and said target gas velocity value.

The method may comprise, after the differential ion mobility analysis by the ion mobility analyser, delivering the ions from the vacuum region through an ion outlet into a downstream vacuum region of the vacuum enclosure and therein conducting mass spectral analysis of the ions.

Preferably, the pre-set relative proportion, R, has a value of between 0.4 and 0.6 (e.g., R=0.5). This range of values has been found to provide good sensitivity and accuracy in determining the gas flow velocity, v=L/T.

Differential ion mobility analysis may include generating a dispersion electric field, E_{D}, across the analytical gap according to an amplitude of a dispersion voltage waveform used to generate the dispersion electric field, E_{D}. Generating the dispersion electric field across the analytical gap may comprise applying an asymmetric waveform (e.g., a square/rectangular waveform) dispersion voltage, V_{D}, to one or more of the electrodes defining the analytical gap thereby to generate the dispersion electric field. The method may include providing a power supply unit comprising switches configured to switch to provide a dispersion voltage waveform, V_{D}, that alternates in polarity between adjustable dispersion voltage amplitude values. Differential ion mobility analysis may include generating a compensation electric field, E_{C}, across the analytical gap. Generating the compensation electric field across the analytical gap may comprise applying a DC compensation voltage, V_{C}, to one or more of the electrodes defining the analytical gap thereby to generate the compensation electric field.

The method preferably includes establishing a flow of gas into the vacuum region so as to provide a gas medium for the differential ion mobility means. In use the vacuum region including the differential ion mobility means is preferably at a pressure, within the vacuum region, of between 1 mbar and 100 mbar, or preferably between, 10 mbar and 40 mbar, or between 30 mbar and 35 mbar.

Desirably, the vacuum region comprises an upstream vacuum sub-region containing the ion inlet and a separate downstream vacuum sub-region containing the ion outlet, the method comprising providing gas flow communication between the upstream vacuum sub-region and the downstream vacuum sub-region via (e.g., only via) the drift region. A benefit of this partitioning of the internal space of the first vacuum region is to inhibit the flow of buffer gas from the ion output end of the drift region of the vDMS assembly from circulating back to the ion input end of the drift region of the vDMS assembly. As a consequence, pressure control within the vacuum region is made easier. The pressure difference between the pressure in the upstream vacuum sub-region and the pressure in the downstream vacuum sub-region may be minimized to be substantially non-existent, or negligibly small, within the limits of pressure gauge measurement accuracy (e.g., below membrane vacuum gauge accuracy). Consequently, a pressure difference between the gas inlet and gas outlet ends of the drift region may be minimized to be substantially non-existent, or negligibly small, within the limits of pressure gauge measurement accuracy.

Preferably, the changing of a rate of flow of gas into or out of the vacuum region comprises providing at the vacuum region an adjustable gas flow port which is other than the ion inlet and the ion outlet and is configured to permit an adjustable flow of gas therethrough into or out of the vacuum region, the method including adjusting the adjustable gas flow port to change a flow of gas therethrough.

Desirably, the changing of a rate of flow of gas into or out of the vacuum region comprises providing each of the upstream vacuum sub-region and the downstream vacuum sub-region a respective adjustable gas flow port which is configured to permit an adjustable flow of gas therethrough into or out of the respective upstream vacuum sub-region or downstream vacuum sub-region, the method including adjusting the respective adjustable gas flow port to change a flow of gas therethrough.

In a second aspect, the invention may provide an ion analysis apparatus comprising:
an ion source configured to generate ions from a sample, and an ion detector wherein in use ions travel along an ion optical axis from the ionization source to the ion detector, the apparatus further comprising:
a vacuum enclosure including a vacuum region comprising an ion inlet and an ion outlet, and containing a differential ion mobility analyzer comprising an ion drift region formed between opposing electrodes defining an analytical gap;
wherein the ion source is configured to deliver the ions through the ion inlet into the vacuum region such that the ions emerge from the ion inlet as a supersonic jet of a buffer gas within which the ions are entrained to enter the drift region such that, in use, ions generated from the sample undergo differential ion mobility analysis, and wherein the differential ion mobility analyzer is configured for subsequently delivering the ions to the ion detector to generate one or more ion mobility spectral peaks;
wherein, the ion analysis apparatus comprises a controller configured to implement the following process:
   a) change a rate of flow of gas into or out of the vacuum region;
   b) measure a gas pressure in the vacuum region and compare the measured gas pressure value to a target gas pressure value;
repeat steps a) and b) until a said gas pressure comparison indicates that the measured gas pressure value has achieved said target gas pressure value;
   c) measure a velocity of gas flow along the drift region by applying a gate voltage pulse across the analytical gap so as to act as an ion shutter, detect an ion mobility spectral peak generated by the ion detector, adjust a pulse width, T, of the gate voltage pulse such that the detected ion mobility spectral peak achieves a reduced height, H2, which is less than a detected maximum height, H1, for that ion mobility spectral peak according to a pre-set relative proportion, R, where R=H2/H1, and determine the gas flow velocity according to the ratio, v, of the pulse width, T, and the axial length, L, of the drift region such that v=L/T;
repeat steps a) to c) until a said measured gas velocity value has achieved a pre-set target gas velocity value;
wherein the ion analysis apparatus is configured to subsequently conduct said differential ion mobility analysis according to the target gas pressure value and the target gas velocity value.

The vacuum enclosure may comprise a downstream vacuum region containing a mass spectrometer, and the ion outlet may be configured for delivering ions from the vacuum region into the downstream vacuum region for conducting mass spectral analysis of the ions.

The apparatus may be configured such that the pre-set relative proportion, R, has a value of between 0.4 and 0.6, (e.g., R=0.5).

The apparatus may be configured to generate a dispersion electric field, E_{D}, across the analytical gap according to an amplitude of a dispersion voltage waveform used to generate the dispersion electric field, E_{D}. Generating the dispersion electric field across the analytical gap may comprise applying an asymmetric waveform (e.g., a square/rectangular waveform) dispersion voltage, V_{D}, to one or more of the electrodes defining the analytical gap thereby to generate the dispersion electric field. The apparatus may comprise a power supply unit comprising switches configured to switch to provide a dispersion voltage waveform, V_{D}, that alternates in polarity between adjustable dispersion voltage amplitude values. The apparatus may be configured to implement a differential ion mobility analysis by a process including generating a compensation electric field, E_{C}, across the analytical gap. The apparatus may be configured to generate the compensation electric field across the analytical gap by applying a DC compensation voltage, V_{C}, to one or more of the electrodes defining the analytical gap thereby to generate the compensation electric field.

Desirably, the vacuum region comprises an upstream vacuum sub-region containing the ion inlet and a separate downstream vacuum sub-region containing the ion outlet, and the apparatus is configured to provide gas flow communication between the upstream vacuum sub-region and the downstream vacuum sub-region via the drift region. As noted above, a benefit of this partitioning of the internal space of the first vacuum region is to inhibit the flow of buffer gas from the ion output end of the drift region of the vDMS assembly from circulating back to the ion input end of the drift region of the vDMS assembly. This makes pressure control within the vacuum region is made easier. The apparatus is preferably configured to minimize a pressure difference between the pressure in the upstream vacuum sub-region and the pressure in the downstream vacuum sub-region so as to be substantially non-existent, or negligibly small, within the limits of pressure gauge measurement accuracy (e.g., below membrane vacuum gauge accuracy). Consequently, the apparatus may provide a pressure difference between the gas inlet and gas outlet ends of the drift region that is minimized to be substantially non-existent, or negligibly small, within the limits of pressure gauge measurement accuracy.

The apparatus may comprise an adjustable gas flow port at the vacuum region which is other than the ion inlet and the ion outlet which is configured to permit an adjustable flow of gas therethrough into or out of the vacuum region, wherein the controller is configured to change a rate of flow of gas into or out of the vacuum region by adjusting the adjustable gas flow port to change a flow of gas therethrough.

The apparatus may be configured such that each of the upstream vacuum sub-region and the downstream vacuum sub-region comprises a respective adjustable gas flow port which is configured to permit an adjustable flow of gas therethrough into or out of the respective upstream vacuum sub-region or downstream vacuum sub-region, wherein the controller is configured to change a rate of flow of gas into or out of a respective upstream vacuum sub-region or downstream vacuum sub-region to change a rate of flow of gas into or out of the first vacuum region.

The apparatus may be configured to provide a pressure range, within the vacuum region, of between 1 mbar and 100 mbar, or preferably between 30 mbar and 35 mbar.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 schematically illustrates an example of a vacuum differential mobility mass spectrometer apparatus.

FIG. 2 schematically illustrates an example of a vacuum differential mobility mass spectrometer apparatus.

FIGS. 3a to 3d schematically illustrates four other examples of a vacuum differential mobility mass spectrometer apparatus.

FIGS. 4a to 4d schematically illustrates four further examples of a vacuum differential mobility mass spectrometer apparatus.

FIGS. 5a and 5b graphically illustrate examples of an ion detector signal concurrently with a series of gate voltages pulses applied across an analytical gap of a drift region of a differential mobility analyser acting as an ion gate through which ions pass or are prevented from passing, alternately.

FIG. 5c graphically illustrates different examples of an ion detector signal according to the application of different gate voltage pulse widths of a gate voltage pulse applied across an analytical gap of a drift region of a differential mobility analyser acting as an ion gate through which ions pass or are prevented from passing.

FIG. 6 schematically illustrates a method for ion analysis.

FIGS. 7a and 7b graphically illustrate heatmaps showing differential mobility spectral peak intensity (height) for samples of an ion when: (a) subject to a drift velocity of 25 m/s in a drift region of a differential mobility analyser; and (b) subject to a drift velocity of 2.6 m/s in the drift region of the differential mobility analyser.

FIG. 8 schematically illustrates components of a low-pressure (LP) FAIMS device.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

lon mobility spectrometry (IMS), such as differential mobility spectrometry (DMS) [I. A. Buryakov, et al., Int. J. Mass Spectrom. Ion Processes 1993, 128, 143] or field asymmetric waveform ion mobility spectrometry (FAIMS) [R. W. Purves, et al., Rev. Sci. Instrum. 1998, 69, 4094] are established methods to separate different types of ions according to differences of their mobility through a gas in response to the application of a force to the ions via an electric field intensity. These mobility differences depend on the physical and chemical properties of ions and gas particles (e.g., neutral particles such as atoms and/or molecules) but are only weakly correlated with the ion mass. The resulting strong orthogonality of this method relative to mass spectrometry (MS) makes FAIMS/MS a powerful analytical approach.

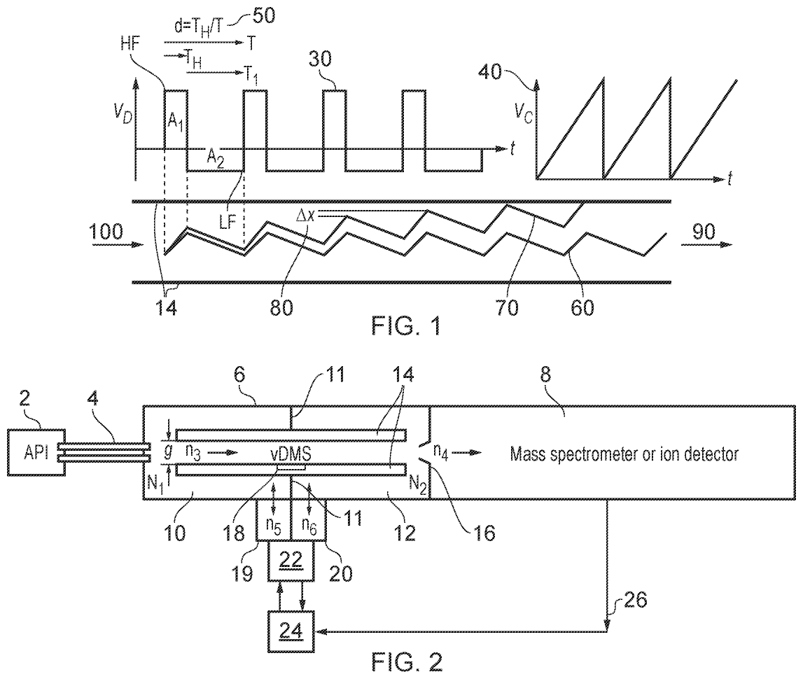

Referring to FIG. 1, there is schematically illustrates the basic principles and the mechanism for IMS separation based on the non-linear ion mobility dependence on electric field and pressure. Ions are entrained in a stream 100 of buffer gas directed along the axis of a drift region defined between two (or more) opposing electrodes 14. A high frequency asymmetric AC waveform 30 is applied to one of the two opposing electrodes. This is known as the dispersion voltage, V_{D}. It is responsible for causing spatial separation of ions according to differences in ion mobility through the buffer gas within which the ions are entrained. The dispersion electric field, E_{D}=−(dV_{D}(x)/dx), generated by the dispersion voltage induces a motion in the ions in a direction of the dispersion electric field extending from one of the two electrodes to the other electrode. Combined with the concurrent drift motion of the ions in the direction of buffer gas flow, the resulting path of ions follows a zig-zag shape as the polarity of the dispersion voltage, V_{D}, alternates between positive and negative values such that the dispersion electric field, E_{D}, alternates between opposite directions across the gas drift direction.

Superimposed to the waveform is a slow compensation DC voltage waveform 40 comprising a succession of “sawtooth” DC ramps. This is known as the compensation voltage, V_{C}. The frequency of the asymmetric waveform 30 of the dispersion voltage, V_{D}, usually spans between a few hundreds of KHz to ˜1 MHz, while that of the “sawtooth” DC ramp 40 typically repeats at a rate of <1 Hz. The amplitude of the asymmetric waveform of the dispersion electric field when the IMS is operated at ambient pressure, is limited by the breakdown limit of the gas flowing within a given electrode geometry and for a parallel plate IMS system the electric field does not generally exceed 3 kV mm⁻¹.

Still referring to FIG. 1, separation of ions is possible using waveforms substantially different to the pure rectangular waveform. A family of waveforms based on quasi-sinusoidal variations of the voltage as a function of time are widely used; these are the bi-sinusoidal, the clipped sinusoidal or other substantially rectangular waveforms. Asymmetric waveforms are designed so that the area of the positive pulse portion of one waveform cycle matches that of the negative pulse portion, i.e., A₁=A₂. For this particular arrangement of time-dependent electric fields, an ion with no mobility dependence on variations in electric field and pressure will therefore be transmitted at zero compensation voltage. The waveform is characterized by its duty cycle 50, usually defined as the width of the short positive pulse part, T_{H}, of one wave cycle, divided by the full duration of one waveform cycle which defines the waveform period T (i.e., defined as: d=T_{H}/T). The sum of the width of the short positive pulse part, T_{H}, and the width of the long negative pulse part, T_{L}, of the wave cycle is equal to the full duration, T, of one waveform cycle.

There exist optimum duty cycles for separating certain types of ions. For example, the type A and C ions are best separated in the IMS spectrum when the duty cycle is d˜0.33. B-type ions exhibit a more complex behaviour and having the ability to vary the duty cycle during the course of an experiment is essential for enhancing instrument performance.

Also shown in FIG. 1 are a stable ion trajectory 60 transmitted successfully through the drift region and a second ion trajectory hitting the top DMS electrode 70. Successful transportation of the lost ion 70 would require the appropriate compensation voltage, V_{C}, 40 to be applied to the IMS electrode to compensate for the small average displacement, Ax, 80 introduced per waveform cycle. By scanning the compensation voltage, V_{C}, ions with different non-linear mobility dependencies on electric field and pressure are successively transported through the drift region gap and can either be detected on a plate connected to an electrometer 90 (not shown) or detected/monitored by a mass spectrometer 90 (not shown).

FIG. 2 shows a schematic diagram for a low-pressure FAIMS (LP-FAIMS) apparatus, also referred to herein as a vacuum differential ion mobility apparatus (vDMS). The low-pressure FAIMS (LP-FAIMS) ion analysis apparatus comprises an atmospheric pressure (API) ion source 2 configured to generate ions from a sample. The apparatus further comprises a vacuum enclosure including a first vacuum region 6 containing a differential ion mobility analyzer comprising an ion drift region formed between opposing electrodes 14 defining an analytical gap, g, and a downstream vacuum region 8 containing either an ion detector configured for detecting ions from the first vacuum region to generate one or more ion mobility spectral peaks, or a mass spectral analyzer comprising an ion detector and configured for conducting mass spectral analysis of ions from the first vacuum region.

The API source 2 is configured to generate a flow of ions entrained in a buffer gas directed from the API source along a capillary 4 configured with a capillary outlet opening positioned within the first vacuum region 6. The apparatus is configured such that a flow of buffer gas, with ions entrained therein, passes through the apparatus along an ion optical axis of the apparatus from the ionization source to an ion detector located, either alone or in a mass spectral analyzer, within the downstream vacuum region 8. The downstream vacuum region is configured in gas flow communication with the first vacuum region via an ion outlet 16 of the first vacuum region comprising a skimmer (this outlet also defines the ion inlet of the downstream vacuum region).

The capillary 4 of the ion source is configured to deliver the ions through an ion inlet into the first vacuum region 6 such that the ions emerge from the ion inlet as a supersonic jet of a buffer gas within which the ions are entrained. The gas flow so formed is directed to enter the drift region between the electrodes 14 such that, in use, ions generated from the sample undergo differential ion mobility analysis there. The ion outlet 16 of the first vacuum region 6 is configured to subsequently deliver the ions into the downstream vacuum region 8 for mobility spectral detection or mass spectral analysis there.

The ion analysis apparatus comprises a controller (22, 24) configured to implement the following process prior to conducting the above-mentioned differential ion mobility analysis and mobility spectral detection or mass spectral analysis according of the ions. This process is performed in order to control the speed of flow of buffer gas, and therefore the speed of ions entrained within the buffer gas which travel at the same speed as the buffer gas, so that the speed achieves a desired value. The pressure of the buffer gas within the analytical gap is also controlled by the following process to achieve a desired value. The process permits the speed of buffer gas (and ion) flow in the analytical gap, to be selectively controlled independently of the pressure of buffer gas in the analytical gap. In particular, the process comprises:
a) changing a rate of flow (n₅, n₆) of buffer gas into or out of the first vacuum region;
b) measuring the buffer gas pressure via a pressure sensor 18 located in the drift region of the vDMS assembly within the first vacuum region 6 and comparing the measured gas pressure value to a target gas pressure value;
   repeating steps a) and b) until the buffer gas pressure comparison indicates that the measured gas pressure value has achieved said target gas pressure value. The process then comprises the further steps of:
c) measuring a velocity of the buffer gas flow along the drift region formed between the electrodes 14 of the apparatus;
   repeat steps a) to c) until the measured buffer gas velocity value has achieved a pre-set target gas velocity value.

Once the target buffer gas (and ion) velocity value has been achieved when the buffer gas is at a pressure equal to the target buffer gas pressure, the ion analysis apparatus is configured to subsequently conduct differential ion mobility analysis and/or mass spectral analysis according under those target gas pressure value and target gas velocity value conditions.

The step c) of measuring the velocity of buffer gas flow is performed by the controller comprising a gas flow control assembly (19, 20), a gas pressure monitor unit 22, and a processor unit 24 configured to perform the calculations referred to herein based on values of buffer gas pressure provided by the gas flow controller and gas pressure monitor unit 22 and based on an ion gate voltage a pulse width, T, as follows.

Adjustments to gas intake/outtake in both vacuum sub-regions (10, 12) are conducted while simultaneously monitoring gas speed, v, and vacuum pressure level. The gas velocity measurement consists of applying to the electrodes 14 of the vDMS drift region a gate voltage having a rectangular pulsed waveform shape and adjusting the waveform pulse width (and, optionally, adjusting the frequency of pulses) until an ion detector signal begins to disappear. The rectangular pulsed waveform acts as an ion shutter applying gate voltage pulses to alternately open/close the vDMS drift region to alternately allow/prevent the passage of ions through the drift region. The gate voltage waveform pulse width (and, optionally, adjusting the frequency of pulses) at which the ion detector signal begins to disappear identifies minimum time window required for ions to complete their passage longitudinally along the full length of the drift region. The longitudinal lengths of the opposing electrodes 14 defining the drift region is known and thereby defines that full length of the drift region. The ion velocity under these conditions is thereby calculable by calculating the ratio, v=L/T, of the longitudinal electrode length L and the gate voltage waveform pulse width, T, at which the ion detector signal begins to disappear.

The controller is configured to control a power supply (not shown) to apply a gate voltage pulse having a controlled gate voltage pulse width, T, across the analytical gap, g, defined between the opposing electrodes 14 of the vDMS assembly, such that the electrodes of the assembly act as an ion shutter. The controller (22, 24) is configured to monitor the height of an ion mobility spectral peak detected by the ion detector, i.e., either disposed alone or within a mass spectrometer assembly, within the downstream vacuum region 8. The controller (22, 24) is configured to receive from the ion detector a signal 26 conveying this ion mobility peak height information to permit the controller to conduct this monitoring process.

The controller (22, 24) is configured to adjust a pulse width, T, of the gate voltage pulse applied to the electrodes 14 of the vDMS assembly such that the detected ion mobility spectral peak (as monitored via signal 26) achieves a reduced height, H2, which is less than a maximum height, H1, for that ion mobility spectral peak as detected during the current mobility spectral peak height monitoring process. The reduced height H2 is defined according to a pre-set relative proportion, R, where R=H2/H1. The controller (22, 24) is configured to determine the gas flow velocity, v, according to the ratio of the pulse width, T, and the axial length, L, of the drift region such that v=L/T.

The apparatus is configured such that the pre-set relative proportion, R, has a value of between 0.4 and 0.6, such as R=0.5. This ratio is selected to represent the condition at which the ion detector signal begins to disappear, as discussed above. It is to be understood that the ion detector may reside within the downstream vacuum region either as a stand-alone detector (e.g., for vDMS and FAIMS use) or as a part of a mass spectrometer assembly. If the ion detector is a part of a mass spectrometer assembly, then the mass filtering function of the mass spectrometer may optionally be turned off when determining ion velocity to allow a greater throughput of ions entering the mass spectrometer to reach the detector for the purposes of obtaining ion mobility peak height information, as described above. Of course, once the desired velocity is achieved, the mass filtering function of the mass spectrometer may be turned on.

The process of change in the shape and amplitude of the ion detector signal may be accurately modelled according to the modelling described by G. E. Spangler and C. I. Collins, “Peak Shape Analysis and Plate Theory for Plasma Chromatography”, Analytical Chemistry, Vol. 47, No. 3, March 1975.

Here it was shown that the peak shape and amplitude of the ion detector signal is proportional to the difference between two error functions whose arguments differ by the quantity:

$$\frac{vT}{2 \sqrt{{D}_{L} {t}_{d}}}$$

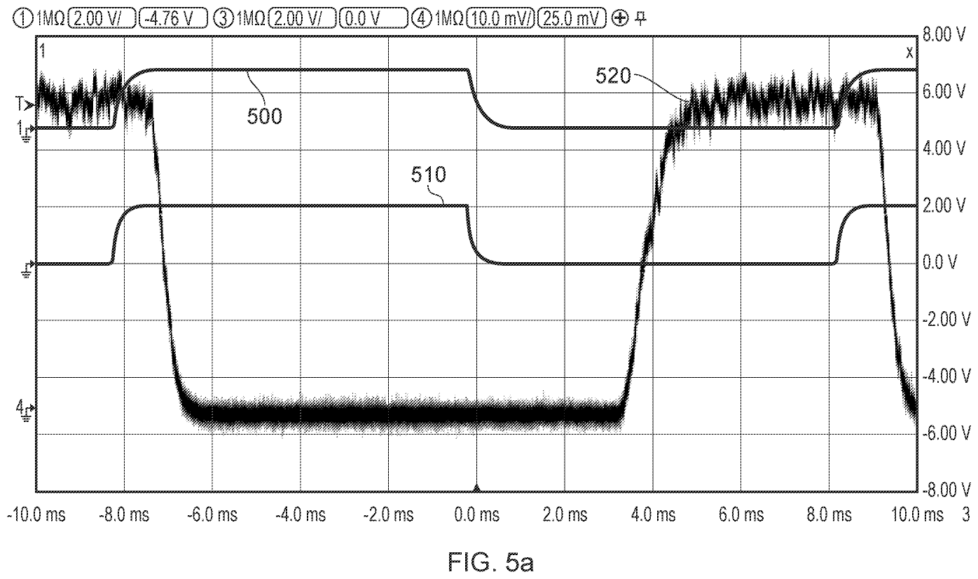

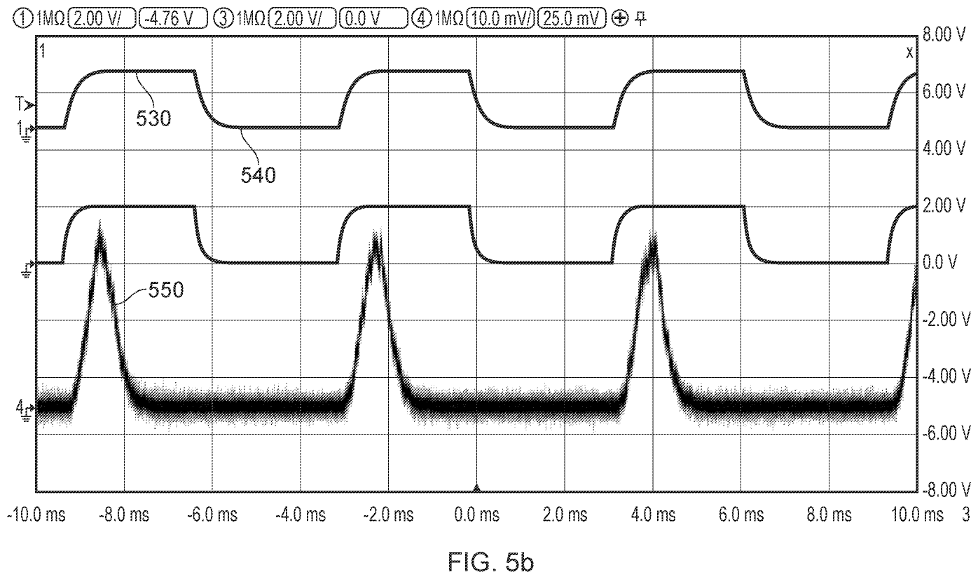

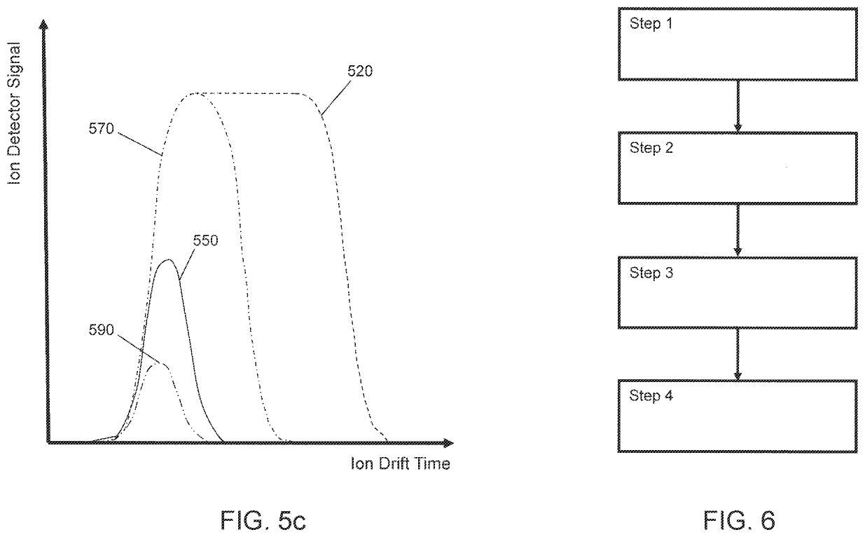

Here, D_{L} is a longitudinal diffusion coefficient of ions within the buffer gas, and t_{d} is the mean ion drift time. When vT<<2\sqrt{Dₗt_{d}}, and the value of vT reduces, the peak shape changes from a flat-topped signal 520, to a Gaussian-shaped peak 570. As vT reduces further, the amplitude of the Gaussian-shaped peak falls further 550 and further 590. Of course, the quantity vT may be caused to reduce by holding the value of v constant and reducing the value of T. The apparatus is preferably configured such that the value of T is reduced until the pre-set relative proportion, R, has a value of between 0.4 and 0.6, such as R=0.5, such as indicated by the Gaussian-shaped peak 550 of FIG. 5c. Of course, other values of R may be used to represent the condition at which the ion detector signal begins to disappear, as discussed above. An example is the Gaussian-shaped peak 590 of FIG. 5c.

### Buffer Gas Velocity Control

The first vacuum region 6 comprises an upstream vacuum sub-region 10 containing the ion inlet (capillary 4 outlet) and a separate downstream vacuum sub-region 12 containing the ion outlet 16. The apparatus is configured to provide gas flow communication between the first vacuum sub-region 10 and the second vacuum sub-region 12 via the drift region defined by the vDMS assembly (electrodes 14).

The controller (22, 24) comprises a first adjustable gas flow port 19 at the upstream vacuum sub-region 10 of the first vacuum region which is configured to permit an adjustable flow (n₅) of gas therethrough into or out of the upstream vacuum sub-region 10 of the first vacuum region. The controller is configured to change a rate of flow (n₅) of gas into or out of the upstream vacuum sub-region 10 by adjusting the adjustable gas flow port to change a flow of gas therethrough.

Similarly, the controller (22, 24) comprises a second adjustable gas flow port 20 at the downstream vacuum sub-region 12 of the first vacuum region which is configured to permit an adjustable flow (n₅) of gas therethrough into or out of the downstream vacuum sub-region 12 of the first vacuum region. The controller is configured to change a rate of flow (n₆) of gas into or out of the downstream vacuum sub-region 12 by adjusting the adjustable gas flow port to change a flow of gas therethrough.

The first vacuum region 6 is partitioned, as noted above, and comprises an upstream vacuum sub-region 10 and the downstream vacuum sub-region 12 partitioned by an internal partitioning wall 11 within the first vacuum region that separates the region into the two sub-regions. A benefit of this partition is to inhibit the flow of buffer gas from the ion output end of the drift region of the vDMS assembly circulating back to the ion input end of the drift region of the vDMS assembly. As a consequence, pressure control within the first vacuum region 6 is made easier.

For example, the controller (22, 24) may be configured to reduce (or increase) the velocity of buffer gas travelling through the analytical gap by increasing (or reducing) a rate of output of gas (e.g., pumping speed) from sub-region 10, and at the same time increasing (or decreasing) a rate of input of external gas into sub-region 12.

The electrodes 14 of the vDMS apparatus extend from the upstream vacuum sub-region 10, through the internal partitioning wall 11 and into the downstream vacuum sub-region 12. The drift region defined by the analytical gap, g, between the electrodes 14 of the vDMS apparatus provides a rate of gas flow, n₃, in the form of the gas flow input from the ion source 2, as a gas jet, which passes from the upstream vacuum sub-region 10 and the downstream vacuum sub-region 12. The upstream vacuum sub-region 10 comprises an adjustable gas flow port 19 which is configured to permit an upstream adjustable flow, n₅, of gas therethrough into or out of the upstream vacuum sub-region. The downstream vacuum sub-region 12 comprises a downstream adjustable gas flow port 20 which is configured to permit an upstream adjustable flow, n₆, of gas therethrough into or out of the downstream vacuum sub-region. The skimmer outlet port 16 of the first vacuum region provides a rate of gas flow, n₄, passing from the first vacuum region 6 to the downstream vacuum region 8. Each if these rates of gas flow, n₃, n₄, n₅, n₆, is defined as the number of buffer gas particles per cubic metre entering/leaving a respective region, per second. Consider a background buffer gas particle density, N₁, of particles per cubic metre in the upstream vacuum sub-region 10, and a background buffer gas particle density of, N₂, particles per cubic metre in the downstream vacuum sub-region 12. The total particle density N of buffer gas particles per cubic metre in the first vacuum region after a time interval, Δt, of gas flow in/out of the first vacuum region may be written as:

$$N = {N}_{1} + {N}_{2} + ( {n}_{3} - {n}_{4} \pm {n}_{5} \pm {n}_{6} ) \times Δ t$$

The total particle density N of buffer gas is a measure of buffer gas pressure. Noting that the drift region defined by the vDMS apparatus has a cross-sectional area A m² as viewed perpendicular to the buffer gas flow direction, in which the gas flow has a speed v m/s. Thus, we may write that the vDMS apparatus provides a rate of gas flow (number of buffer gas particles per cubic metre per second), n₃ as:

$${n}_{3} = {N}_{3} \times A \times v$$

$$This gives :$$

$$N = {N}_{1} + {N}_{2} + ( {N}_{3} \times A \times v - {n}_{4} \pm {n}_{5} \pm {n}_{6} ) \times Δ t$$

In order to achieve a stable pressure value, the quantity N must not change with time. This requires that:

$$( {N}_{3} \times A \times v - {n}_{4} \pm {n}_{5} \pm {n}_{6} ) = 0$$

Rearranging this equation gives:

$$v = \frac{( {n}_{4} \pm {n}_{5} \pm {n}_{6} )}{A \times {N}_{3}}$$

Thus, by controlling the buffer gas particle number flow rates n₅ and n₆ into and/or out of the first vacuum region 6, it is possible to control the velocity v of buffer gas drift, and entrained ion velocity, along the drift region of the vDMS device for given stable values of buffer gas particle number density, N₃, in the drift region, and buffer gas particle number flow rate, n₄, in to the downstream vacuum region 8. Control of the buffer gas particle number flow rates n₅ and n₆ and calculation of the resulting buffer gas flow velocity, v, is performed by computer or microcontroller within the controller unit 24, as discussed above.

### Subsequent IMS (e.g., LP-FAIMS/vDMS)

Once a desired buffer gas flow velocity, v, and buffer gas pressure, are achieved, a power supply unit (not shown) is configured to apply the dispersion voltage waveform V_{D} to the electrodes 14 of the vDMS apparatus to generate between them a dispersion electric field, E_{D}, across the analytical gap (g). The power supply unit comprises switches (not shown) configured to switch to provide the AC dispersion voltage waveform, V_{D}, and DC voltage, V_{C}, such that vDMS may be performed as described above with reference to FIG. 1. The power supply unit may be configured to generate the dispersion voltage waveform 3 by fast electronic switches that alternate between high-field (HF) and low-field (LF) voltage amplitude extremes of the waveform 3 (see FIG. 1) that are provided by a power supply.

The control unit 24 is configured to control the power supply and monitoring unit 22 to supply to the electrodes 14 of the drift region, an asymmetric AC waveform 3 of the dispersion voltage, V_{D}, and a DC compensation voltage, V_{C}, described above with reference to FIG. 1. The dispersion voltage, V_{D}, consists of high field (HF) and low field (LF) segments. This dispersion voltage, V_{D}, creates a dispersion electric field E_{D}=−(dV_{D}(x)/dx)=−V_{D}/g which spans the analytical gap, g, all along the drift region and extends in a direction perpendicular to the longitudinal axis of the drift region and alternating in polarity. The DC compensation voltage, V_{C}, also generates a compensation electric field E_{C}=−(dV_{C}(x)/dx)=−V_{C}/g which spans the analytical gap, g, all along the drift region and extends in a direction perpendicular to the longitudinal axis of the drift region.

For example, the first vacuum region 6 may comprise a vDMS apparatus configured to perform as an LP-FAIMS device 14 between the atmospheric-pressure ionization (API) 2 and a mass spectrometer (MS) stage 8. The electrospray ionization (ESI) source 2 may be configured, as is known in the art, such that a sample in a suitable solvent is delivered to the API to create a plume of charged droplets. At least some of the droplets pass into a desolvation tube defined by the capillary 4, where those droplets evaporate and release ions. The ions are entrained in a supersonic gas jet of buffer gas exiting the outlet of the capillary into the first vacuum region a pressure of 1 mbar to 100 mbar in a direction into the analytical gap, g, and along the drift region. The electrodes 14 defining the drift region transmit the ion-entrained buffer gas flow to the ion outlet skimmer 16. Ion species with selected differential mobility values pass through the ion outlet skimmer 16 for onward analysis by the mass spectrometer 8. Other ion species without the selected differential mobility values are deflected toward the FAIMS electrodes 14 and are neutralised upon landing on the electrode surfaces.

Pressure sensor 18 can be placed within the drift region (as shown) or may be placed elsewhere in first vacuum region. Pressure sensor 18 may comprise a pressure gauge, such as a membrane gauge or Pirani cathode. A membrane gauge is preferable because does not need additional calibration for the gas type. As noted above, pressure measurement is preferably performed at a location within the first vacuum chamber that is sufficiently far from the ion inlet capillary (desolvation tube) 4 to avoid supersonic gas jet pressure distortion, and sufficiently far from the ion outlet skimmer 16 where gas exiting to the mass spectrometer 8 forms another gas jet.

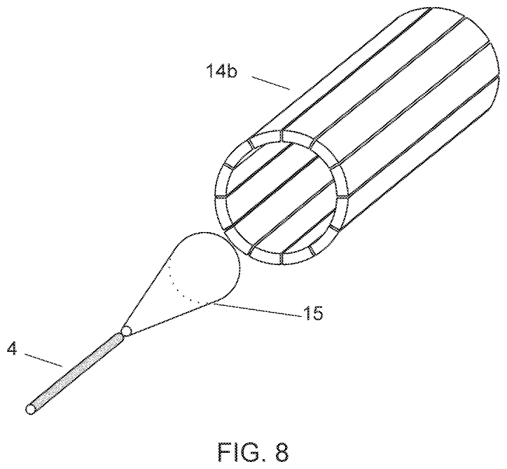

The low-pressure FAIMS (LP-FAIMS) of the example illustrated in FIG. 2 may operate with both planar electrode configurations of electrodes 14 defining the drift region, and multipole configurations (e.g., item 14b of FIG. 8).

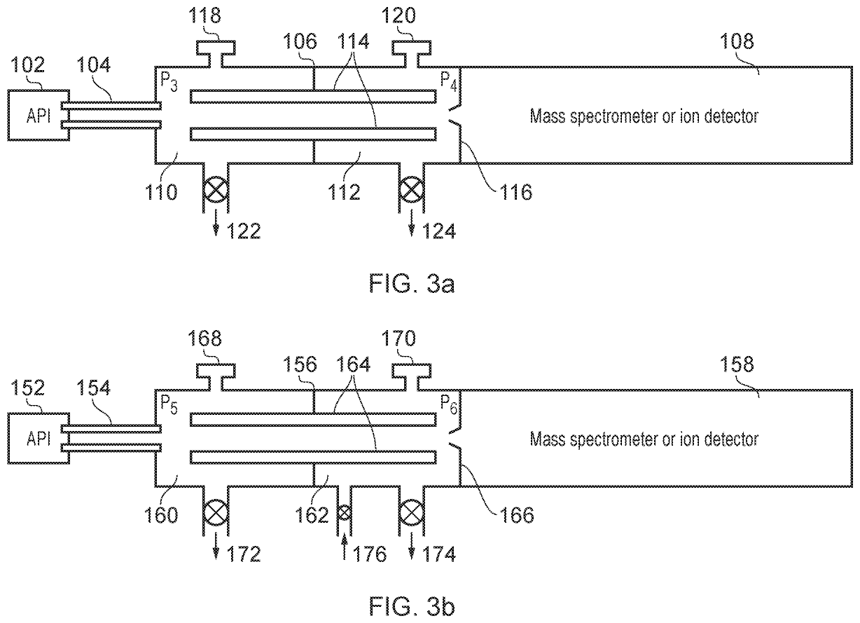

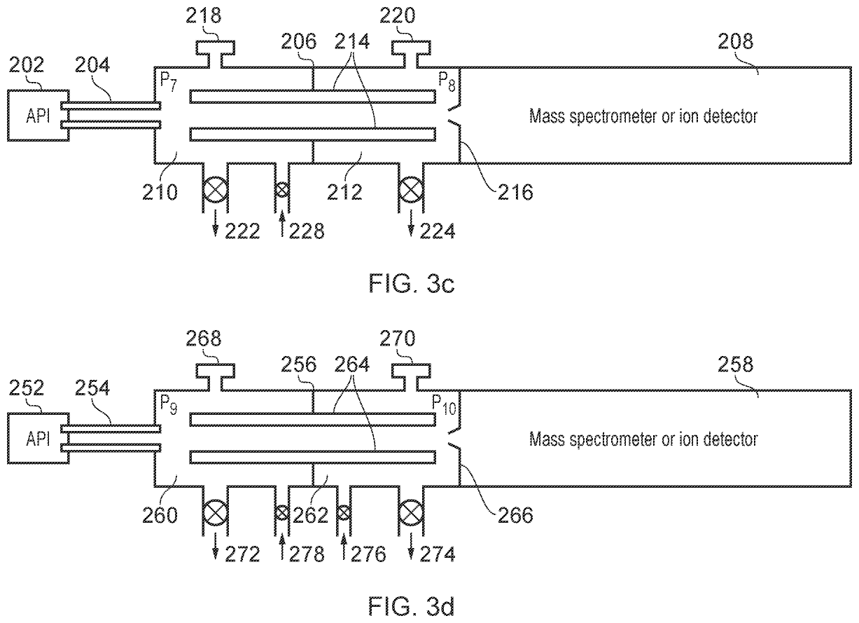

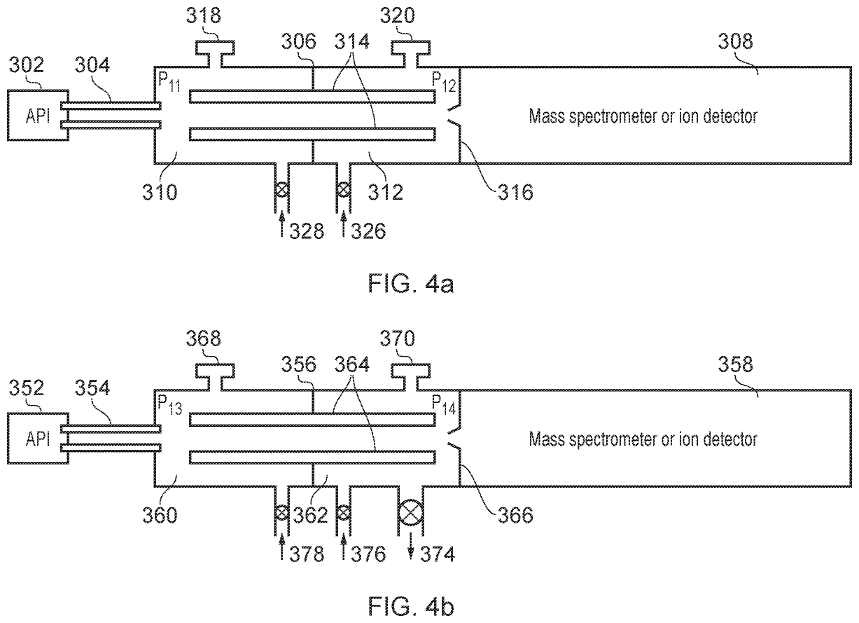

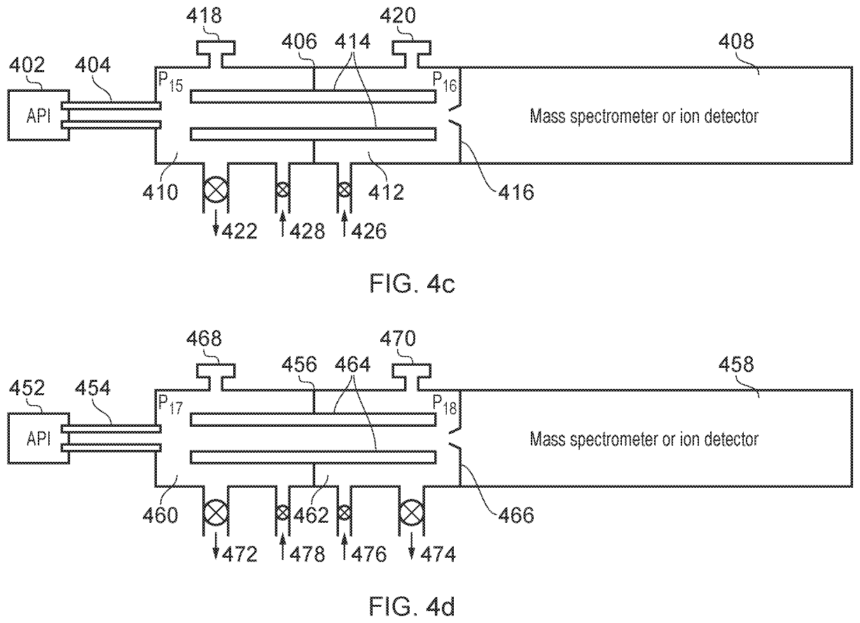

Depending on pumping speed through the skimmer 16 and gas intake through the capillary 4 there are two cases arising. A first case is considered by the examples shown in FIGS. 3a to 3d, where sample/buffer gas intake (104, 154, 204, 254) to the first vacuum region is greater or equal than gas intake (116, 166, 216, 266) through the skimmer into the downstream vacuum region (108, 158, 208, 258). A second case is considered by the examples shown in FIGS. 4a to 4d, where sample/buffer gas intake (304, 354, 404, 454) to the first vacuum region is smaller or than gas intake (316, 366, 416, 466) through the skimmer into the downstream vacuum region (308, 358, 408, 458). It is to be understood that, although not explicitly shown in FIGS. 3a to 3d, or in FIGS. 4a to 4d, the components shown in the apparatus of FIG. 2, including the pressure sensor 18, the gas flow control assembly (19, 20), the gas pressure monitor unit 22, and the processor unit 24 are indeed included, and are configured to operate as described herein with reference to FIG. 2, but are omitted from FIGS. 3a to 3d, and FIGS. 4a to 4d merely to aid clarity.

In an experiment according to the example of FIG. 3b, Glutamine and Lysine sample was delivered from electrospray source 152, entered capillary 154 into front vDMS chamber 160. Sample carried by buffer gas flow moved between electrodes 164 into back vDMS chamber 162. From the rear chamber 162 sample with buffer gas was carried into a single quad mass spectrometer 158 through a skimmer 166. The pressure in vDMS 156 was set to one value from the range 10-40 mbar. The total pressure in vDMS was measured with membrane vacuum gauges on both chambers 168,170. The pressure difference between chambers 160 and 162 was below membrane vacuum gauge accuracy. The inside pressure was initially adjusted with a valve 174 connected to roughing pump. The requested vDMS operating pressure (e.g., for a given experiment), Pr, was adjusted by adding Nitrogen (N₂) gas through valve 176 which is a mass flow controller steered by computer reading pressure from the vacuum gauge 168 or 170. Initial adjustment trough valve 174 due to limited pressure range which could be reached through mass flow controller inlet 176. The mass flow controller inlet 176 was used due to higher precision in vacuum level control than motorised valve with connection to roughing pump.

To measure gas velocity vDMS the waveform generator was detached from the electrodes 14. A square ion gate pulsed waveform generator was delivered to the electrodes 14 of the vDMS assembly. FIG. 5a shows the signal (520) from the ion detector within the mass spectrometer 158 when attached to an oscilloscope together with signal from the square waveform generator (510) and reference signal from electrodes (500). The ion gate signal pulse width, T, was set to a longer value (low pulse frequency) to open the electrodes for ions for a longer time, and the height of the flat ion peak was measured via the ion detector signal. To find the ion (and buffer gas) transit time through the drift region, the pulse width, T, ion gate signal 530 was set to a shorter value (higher pulse frequency) at the pulse generator and tuned in value until the peak of the from the signal 550 from the ion detector within the mass spectrometer 158 was reduced to 50% of the previous maximum peak height, as shown in FIG. 5b. This 50% value of the initial maximum peak was chosen as being the ion signal peak height one would expect to observe when the average value of the buffer gas velocity distribution matches the minimum gas velocity required for ions to traverse the length of the drift region in between successive applications of the ion gate signal applied to the electrodes 14 of the vDMS assembly. This ion gate signal pulse frequency provides the minimum time when the gate formed between the electrodes of the vDMS assembly is open for ions to fly through and, accordingly this identified the ion transit time. Because the length of the electrodes 14 of the vDMS assembly is known, from this the average gas velocity may be calculated.

To reach a target gas velocity the above adjustment loop comprising steps a) to c) is performed as described above. This process includes: opening front chamber valve 172 and increasing pumping speed there; then, waiting for pressure to go back to a target Pr value which is done by computer steered mass flow controller through inlet 176; then, performing gas velocity measurement.

FIGS. 3a to 3d concern a case when sample/buffer gas intake 104, 154, 204, 254 is greater than or equal to the pumping speed through the skimmer 116, 166, 216, 266 into the downstream vacuum region 108, 158, 208, 258.

FIG. 3a shows setup configuration with a valve 122 connected to a roughing pump in the front chamber 110 and a valve 124 connected to a roughing pump in the rear chamber 112. Both valves 122, 124 could be motorised to choke a pumping speed from a roughing pump. Pumping rate differences between chambers 110, 112 can be regulated trough that valves 122, 124 without additional N₂ inlet. The same principles as described above are used to set buffer gas velocity and keep pressure Pᵣ unchanged.

FIG. 3b shows a configuration with a valve 172 connected to a roughing pump in the front chamber 160 and a valve 174 connected to a roughing pump in the rear chamber 162. Additional gas inlet 176 could be steered by mass flow controller is added to the rear chamber 162 for more precise pressure adjustment. Both valves 172, 174 could be motorised to choke a pumping speed from a roughing pump. Pumping rate differences between chambers 160,162 can be regulated through valves 172, 174 with additional buffer gas (N₂) inlet 176. The same principles as described above are used to set buffer gas velocity and keep pressure Pᵣ unchanged.

FIG. 3c shows a configuration with a valve 222 connected to a roughing pump in the front chamber 210 and a valve 224 connected to a roughing pump in the rear chamber 212. Additional gas inlet 228 could be steered by mass flow controller is added to the front chamber 210 for more precise pressure adjustment. Both valves 222,224 could be motorised to choke a pumping speed from a roughing pump. Pumping rate differences between chambers 160, 162 can be regulated through valves 222,224 with additional buffer gas (N₂) inlet 228. The same principles as described above are used to set buffer gas velocity and keep pressure Pr unchanged.

FIG. 3d shows a configuration with a valve 272 connected to a roughing pump in the front chamber 260 and a valve 274 connected to a roughing pump in the rear chamber 262. Additional gas inlet 278 could be steered by mass flow controller is added to the front chamber 228 and additional gas inlet 276 is added to the rear chamber 262 for more precise pressure adjustment. Both valves 272,274 could be motorised to choke a pumping speed from a roughing pump. Pumping rate differences between chambers 260,262 can be regulated through valves 272,274 with additional buffer gas (N₂) inlets 278 and 276. The same principles as described above are used to set buffer gas velocity and keep pressure Pr unchanged.

FIGS. 4a to 4d concern a case when sample/buffer gas intake 304, 354, 404, 454 is greater or equal than gas intake to the downstream vacuum region (308, 358, 408, 458) through the skimmer 316, 366, 416,466.

FIG. 4a shows setup configuration with an inlet 328 in the front chamber 310 and an inlet 326 in the rear chamber 312. Both inlets 328,326 could be used with mass flow controller and N₂ input. Pumping rate differences between chambers 310,312 can be regulated trough that inlets 328,326 without additional outlet with valve to a roughing pump. The same principles as described above are used to set buffer gas velocity and keep pressure Pr unchanged.

FIG. 4b shows setup configuration with an inlet 378 in the front chamber 360 and an inlet 376 in the rear chamber 362. Both inlets 378,376 could be used with mass flow controller and N₂ input. Pumping rate differences between chambers 360,362 can be regulated through inlets 378,376 with additional outlet in a rear chamber 374 with valve to a roughing pump. The valve can be motorised. The same principles as described above are used to set buffer gas velocity and keep pressure Pr unchanged.

FIG. 4c shows setup configuration with an inlet 428 in the front chamber 410 and an inlet 426 in the rear chamber 412. Both inlets 428,426 could be used with mass flow controller and N₂ input. Pumping rate differences between chambers 410,412 can be regulated through inlets 428,426 with additional outlet in a front chamber 410 with valve to a roughing pump. The valve can be motorised. The same principles as described above are used to set buffer gas velocity and keep pressure Pr unchanged.

FIG. 4d shows setup configuration with an inlet 478 in the front chamber 460 and an inlet 476 in the rear chamber 462. Both inlets 478,476 could be used with mass flow controller and N₂ input. Pumping rate differences between chambers 460,462 can be regulated through inlets 478,476 with additional outlet in a front chamber 410 and additional outlet in rear chamber 474, both with valve to a roughing pump. The valves can be motorised. The same principles as described above are used to set buffer gas velocity and keep pressure Pr unchanged.

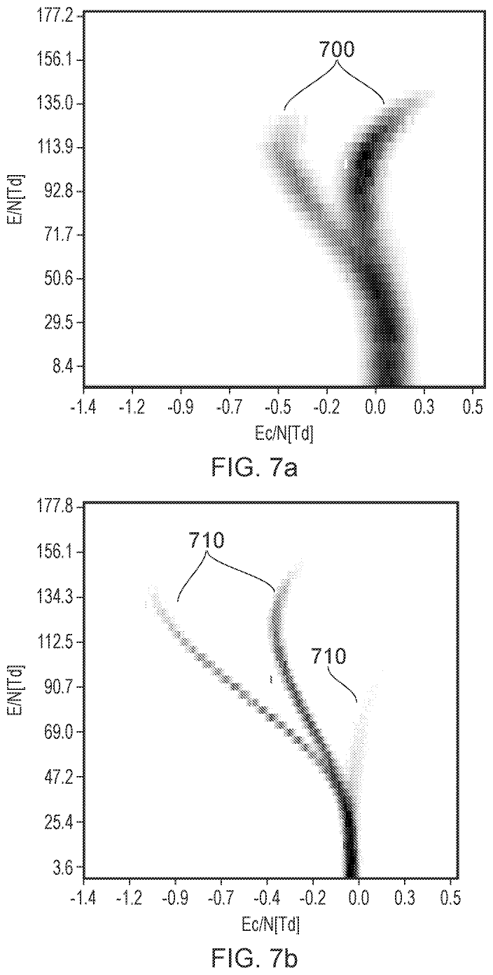

An ion signal intensity heatmap for Glutamine and Lysine for buffer gas is shown in FIGS. 7a and 7b. The figures show heat maps of the ratios E_{D}/N vs E_{C}/N, where E_{D}/N is the ratio of the dispersion electric field strength E_{D} to neutral buffer gas particle number density, N, and E_{C}/N is the ratio of the compensation electric field strength E_{C} to neutral buffer gas particle number density. The units of E/N are Townsends (Td) where 1 Td=10⁻¹⁷ Vcm². This data is for a Glutamine and Lysine mixture measured in the vDMS for a buffer gas pressure of 32 mbar. FIG. 7a shows results from measurement performed for the setup without gas velocity regulation 25 m/s with resolution 3. FIG. 7b shows results from measurement performed with buffer gas velocity, v, reduced as described above to v=2.6 m/s, and this achieves an ion mobility resolution of 11.

The invention permits adjustment of buffer (and ion) velocity in a jet driven LP-FAIMS/vDMS device. This has several benefits. One benefit is increased resolving power. Another benefit is increase in the transmission. The invention enables adjustment the gas velocity for given geometry of LP-FAIMS/vDMS device whilst simultaneously keeping vacuum in the device unchanged. A given geometry of LP-FAIMS/vDMS device may provide a given gas velocity into the first vacuum region due to the geometry at and around the outlet of its ion source. This gas pressure is typically dependent on the LP-FAIMS/vDMS operating pressure within the drift region. However, different LP-FAIMS/vDMS pressures are optimal for different ion types. In prior art systems it is not possible to vary the LP-FAIMS/vDMS pressure and gas velocity independently of each other, and so it is not possible to fully optimise LP-FAIMS/vDMS device for a range of sample ion types. The present invention permits this optimisation.

Ion separation efficiency depends how many waveform cycles the ions can experience and the velocity of a buffer gas carrying entrained ions is one of the factors. Extending ion residence time inside the drift region provides better ion separation and increased resolving power. This is achieved by reducing buffer gas velocity without affecting vacuum levels in the drift region between electrodes.

Higher resolving power can be obtained when the gas velocity, through LP-FAIMS/vDMS devices is reduced. The ions are carried through the LP-FAIMS in the gas flow. That is, ions are entrained in a gas jet, and the ion velocity and the gas velocity can be considered equal. Achieving the same gas velocity at different vacuum levels is also important for consistent measurements.

In existing vacuum DMS devices (vDMS), a buffer gas velocity is depended on the pressure of the vacuum region containing ion flow and cannot be adjusted on demand. They show a significant decrease of resolving power due to the high gas velocities they entail. Keeping constant gas velocity for any requested vacuum value from the available range is important for consistent measurements, and the present invention permits users to set a buffer gas velocity on demand for a given vacuum value in the instrument. The present invention employs pressure regulation and gas pumping in the context of jet driven gas flow, associated with an API source, and a process to control a buffer gas velocity in an IMS apparatus (e.g., LP-FAIMS/vDMS) for providing higher resolving power.

FIG. 6 illustrates a method for analyzing ions by lon Mobility Spectrometry (IMS) by a process comprising the following steps:
Step 1: Generating ions from a sample in an ion source, delivering them entrained in a buffer gas (preferably the buffer gas is a supersonic jet) into an ion mobility analyser in a vacuum region containing an ion drift region formed between electrodes defining an analytical gap.
Step 2: Prior to conducting differential ion mobility analysis of the ions:
   a) changing a rate of flow of gas into or out of the vacuum region;
   b) measuring a gas pressure in the vacuum region; and, repeating steps a) and b) until the measured gas pressure value achieves a pre-set target gas pressure value.
Step 3: Subsequent to Step 2:
   c) measuring a velocity of gas flow along the drift region, as described herein; and, repeating steps a) to c) until the measured gas velocity value achieves a pre-set target gas velocity value.
Step 4: Subsequent to Step 3, conducting differential ion mobility analysis in the entrained ions according to the target gas pressure value and the target gas velocity value.

Referring to FIG. 2, upon entering the first vacuum region 6, ions and neutral buffer gas particles form a jet and a conical-or bell-shaped gas flow shaper element 15 may optionally be used for shaping and directing the gas flow into a set of elongated electrodes comprising the FAIMS device. This is shown schematically in FIG. 8. The downstream vacuum region 8 may be maintained at a lower pressure than the first vacuum region by a pump (not shown). A dodecapole electrode assembly may be provided as the FAIMS device 14b, as an example, instead of a planar-plate electrode assembly shown in FIG. 2. A smooth transition of the gas entering the first vacuum region is achieved by matching the entrance diameter of the conical gas flow shaper 15 to that of the inlet capillary 4 and matching the exit diameter of the conical gas flow shaper 15 to that of the entrance of the cylindrical dodecapole 14b. It is to be understood that this alternative arrangement may also apply to the examples described above with reference to FIGS. 3a to 3d and FIGS. 4a to 4d.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.
A. Buryakov, et al., Int. J. Mass Spectrom. lon Processes 1993, 128, p143
R. W. Purves, et al., Rev. Sci. Instrum. 1998, 69, p4094
G. E. Spangler and C. I Collins, “Peak Shape Analysis and Plate Theory for Plasma Chromatography”, Analytical Chemistry, Vol. 47, No. 3, March 1975.
U.S. Pat. No. 8,610,054 B2
U.S. Pat. No. 8,084,736 B2

1. A method of analyzing ions, which method comprises:
generating ions from a sample in an ion source;
delivering the ions through an ion inlet into a vacuum region of a vacuum enclosure comprising a differential ion mobility analyser which comprises an ion drift region formed between opposing electrodes defining an analytical gap, wherein the ions emerge from the ion inlet as a supersonic jet of a buffer gas within which the ions are entrained to enter the drift region;
delivering the ions from the differential ion mobility analyser to an ion detector to generate one or more ion mobility spectral peaks;
wherein the method comprises:
a) changing a rate of flow of gas into or out of the vacuum region;
b) measuring a gas pressure in the vacuum region and comparing the measured gas pressure value to a target gas pressure value;
repeating steps a) and b) until a said gas pressure comparison indicates that the measured gas pressure value has achieved said target gas pressure value;
c) measuring a velocity of gas flow along the drift region by applying a gate voltage pulse across the analytical gap so as to act as an ion shutter, detecting an ion mobility spectral peak generated by the ion detector and adjusting a pulse width of the gate voltage pulse such that the detected ion mobility spectral peak achieves a reduced height (H2) which is less than a detected maximum height (H1) for that ion mobility spectral peak according to a pre-set relative proportion, R, where R=H2/H1, and determining the gas flow velocity according to the ratio, v, of the pulse width, T, and the axial length, L, of the drift region such that v=L/T; and
repeating steps a) to c) until a said measured gas velocity value has achieved a pre-set target gas velocity value, and subsequently conducting differential ion mobility analysis by the differential ion mobility analyser according to said target gas pressure value and said target gas velocity value.

2. The method according to claim 1 comprising, after said differential ion mobility analysis by the ion mobility analyser, delivering the ions from the vacuum region through an ion outlet into a downstream vacuum region of the vacuum enclosure and therein conducting mass spectral analysis of the ions.

3. The method according to claim 1, wherein the pre-set relative proportion, R, has a value of between 0.4 and 0.6.

4. The method according to any preceding claim 1, wherein the vacuum region comprises an upstream vacuum sub-region containing the ion inlet and a separate downstream vacuum sub-region containing the ion outlet, the method comprising providing gas flow communication between the upstream vacuum sub-region and the downstream vacuum sub-region via the drift region.

5. The method according to any preceding claim 1, wherein said changing a rate of flow of gas into or out of the vacuum region comprises providing at the vacuum region an adjustable gas flow port which is other than the ion inlet and the ion outlet and is configured to permit an adjustable flow of gas therethrough into or out of the vacuum region, the method including adjusting the adjustable gas flow port to change a flow of gas therethrough.

6. The method according to claim 1,
wherein the vacuum region comprises an upstream vacuum sub-region containing the ion inlet and a separate downstream vacuum sub-region containing the ion outlet, the method comprising providing gas flow communication between the upstream vacuum sub-region and the downstream vacuum sub-region via the drift region,
wherein said changing a rate of flow of gas into or out of the vacuum region comprises providing at the vacuum region an adjustable gas flow port which is other than the ion inlet and the ion outlet and is configured to permit an adjustable flow of gas therethrough into or out of the vacuum region, the method including adjusting the adjustable gas flow port to change a flow of gas therethrough, and
wherein said changing a rate of flow of gas into or out of the vacuum region comprises providing each of the upstream vacuum sub-region and the downstream vacuum sub-region a respective adjustable gas flow port which is configured to permit an adjustable flow of gas therethrough into or out of the respective upstream vacuum sub-region or downstream vacuum sub-region, the method including adjusting the respective adjustable gas flow port to change a flow of gas therethrough.

7. An ion analysis apparatus comprising:
an ion source configured to generate ions from a sample, and an ion detector wherein in use ions travel along an ion optical axis from the ionization source to the ion detector, the apparatus further comprising:
a vacuum enclosure including a vacuum region comprising an ion inlet and an ion outlet, and containing a differential ion mobility analyzer comprising an ion drift region formed between opposing electrodes defining an analytical gap;
wherein the ion source is configured to deliver the ions through the ion inlet into the vacuum region such that the ions emerge from the ion inlet as a supersonic jet of a buffer gas within which the ions are entrained to enter the drift region such that, in use, ions generated from the sample undergo differential ion mobility analysis, and wherein the differential ion mobility analyzer is configured for subsequently delivering the ions to the ion detector to generate one or more ion mobility spectral peaks;
wherein, the ion analysis apparatus comprises a controller configured to implement the following process:
a) change a rate of flow of gas into or out of the vacuum region;
b) measure a gas pressure in the vacuum region and compare the measured gas pressure value to a target gas pressure value;
repeat steps a) and b) until a said gas pressure comparison indicates that the measured gas pressure value has achieved said target gas pressure value;
c) measure a velocity of gas flow along the drift region by applying a gate voltage pulse across the analytical gap so as to act as an ion shutter, detect an ion mobility spectral peak generated by the ion detector, adjust a pulse width, T, of the gate voltage pulse such that the detected ion mobility spectral peak achieves a reduced height, H2, which is less than a detected maximum height, H1, for that ion mobility spectral peak according to a pre-set relative proportion, R, where R=H2/H1, and determine the gas flow velocity according to the ratio, v, of the pulse width, T, and the axial length, L, of the drift region such that v=L/T; and
repeat steps a) to c) until a said measured gas velocity value has achieved a pre-set target gas velocity value;
wherein the ion analysis apparatus is configured to subsequently conduct said differential ion mobility analysis according to said target gas pressure value and said target gas velocity value.

8. The apparatus according to claim 7 wherein the vacuum enclosure comprises a downstream vacuum region containing a mass spectrometer, and the ion outlet is configured for delivering ions from the vacuum region into the downstream vacuum region for conducting mass spectral analysis of the ions.

9. The apparatus according to claim 7, wherein the pre-set relative proportion, R, has a value of between 0.4 and 0.6.

10. The apparatus according to claim 7, wherein the vacuum region comprises an upstream vacuum sub-region containing the ion inlet and a separate downstream vacuum sub-region containing the ion outlet, and the apparatus is configured to provide gas flow communication between the upstream vacuum sub-region and the downstream vacuum sub-region via the drift region.

11. The apparatus according to claim 7, comprising an adjustable gas flow port at the vacuum region which is other than the ion inlet and the ion outlet which is configured to permit an adjustable flow of gas therethrough into or out of the vacuum region, wherein the controller is configured to change a rate of flow of gas into or out of the vacuum region by adjusting the adjustable gas flow port to change a flow of gas therethrough.

12. The apparatus according to claim 7,
wherein the vacuum region comprises an upstream vacuum sub-region containing the ion inlet and a separate downstream vacuum sub-region containing the ion outlet, and the apparatus is configured to provide gas flow communication between the upstream vacuum sub-region and the downstream vacuum sub-region via the drift region,
wherein the apparatus comprises an adjustable gas flow port at the vacuum region which is other than the ion inlet and the ion outlet which is configured to permit an adjustable flow of gas therethrough into or out of the vacuum region, wherein the controller is configured to change a rate of flow of gas into or out of the vacuum region by adjusting the adjustable gas flow port to change a flow of gas therethrough, and
wherein each of the upstream vacuum sub-region and the downstream vacuum sub-region comprises a respective adjustable gas flow port which is configured to permit an adjustable flow of gas therethrough into or out of the respective upstream vacuum sub-region or downstream vacuum sub-region, wherein the controller is configured to change a rate of flow of gas into or out of a respective upstream vacuum sub-region or downstream vacuum sub-region to change a rate of flow of gas into or out of the vacuum region.
